(19) United States
(12) Patent Application Publication
(10) Pub. No.: US 2004/0170796 A1
(43) Pub. Date: Sep. 2, 2004

(54) Assembled pad formed by multiple EVA mats

(76) Inventor: Yao-Chen Chuang, Taichung (TW)

Correspondence Address: YAO-CHEN CHUANG, P.O. BOX 2103, Taichung, TW

(21) Appl. No.: 10/374,200

(22) Filed: Feb. 27, 2003

(51) Int. Cl. B32B 3/10

(52) U.S. Cl. 428/44

(57) ABSTRACT

An assembled pad includes multiple assembled mats connected to one another to define at least one cavity for receiving at least one subject matter. Each assembled mat is made of EVA and includes at least one tenon laterally extending therefrom and at least one mortise laterally defined to receive a corresponding one of the tenons of a corresponding one of adjacent assembled mats. The assembled pad has an undulated top surface for providing an excitation to an infant child who plays on the assembled floor. Each assembled mat has an irregular shape and a connecting edges between two adjacent assembled mats, and the subject matter and the assembled mats are flushed on each other for a smooth touch. The subject matter is a three-dimensional model such that the assembled pad has a vivid vision.

### BACKGROUND OF THE INVENTION

1. Field of the Invention

The present invention relates to an assembled pad, and more particularly to an assembled pad formed by multiple EVA (Ethylene Vinyl Acetate) mats.

2. Description of Related Art

A conventional EVA building block for forming an assembled pad in accordance with the prior art shown in FIG. 4 comprises multiple assembled mats (50) connected to one another. The assembled mat (50) is polygonal and each side of the assembled mat (50) has multiple tenons (51) laterally extending from each side of the assembled mat (50). A mortise (52) is laterally defined in the assembled mat (50) between every two adjacent tenons (51) for receiving a corresponding one of the tenons (51) of an adjacent assembled mat (50).

The EVA assembled pad is usually provided to prevent an infant child from an injury due to the hard floor. However, the shape of the assembled mat (50) is monotone and has only one function that is to prevent an infant child from an injury. Consequently, another conventional EVA assembled pad with vivid shape is marketed.

With reference to FIGS. 5 and 5A, the second embodiment of the conventional assembled pad comprises multiple assembled mats (60) each has an irregular shape and connected to one another. The assembled mats (60) are connected to one another by mortise (61) and tenon (62). As a result, the second embodiment of the conventional assembled pad has a vivid vision to the user. However, the top surface provided to the user is plane that cannot give an excitation to the sole of the infant child who plays on the assembled pad.

The present invention has arisen to mitigate and/or obviate the disadvantages of the two conventional EVA assembled pad.

### SUMMARY OF THE INVENTION

The main objective of the present invention is to provide an improved assembled pad formed by multiple EVA mats.

To achieve the objective, the assembled pad in accordance with the present invention comprises multiple assembled mats connected to one another to define at least one cavity for receiving at least one subject matter. Each assembled mat is made of EVA and includes at least one tenon laterally extending therefrom and at least one mortise laterally defined to receive a corresponding one of the tenons of a corresponding one of adjacent assembled mats. The assembled pad has an undulated top surface for providing an excitation to an infant child who plays on the assembled floor. Each assembled mat has an irregular shape and a connecting edges between two adjacent assembled mats, and the subject matter and the assembled mats are flushed on each other for a smooth touch. The subject matter is a three-dimensional model such that the assembled pad has a vivid vision.

Further benefits and advantages of the present invention will become apparent after a careful reading of the detailed description with appropriate reference to the accompanying drawings.

### BRIEF DESCRIPTION OF THE DRAWINGS

FIG. 1 is a partially exploded perspective view of an assembled pad formed by multiple EVA mats in accordance with the present invention;

FIG. 2 is a top plan view of the assembled pad in FIG. 1;

FIG. 2A is a side plan view of the assembled pad in FIG. 2

FIG. 3 a top plan view of another embodiment of the assembled pad in accordance with the present invention;

FIG. 3A is a side plan view of the assembled pad in FIG. 3;

FIG. 4 is a top plan view of a first conventional assembled pad in accordance with the prior art;

FIG. 5 is top plan view of a second conventional assembled pad in accordance with the prior art; and

FIG. 5A is a side plan view of the second conventional assembled pad in FIG. 5.

### DETAILED DESCRIPTION OF THE INVENTION

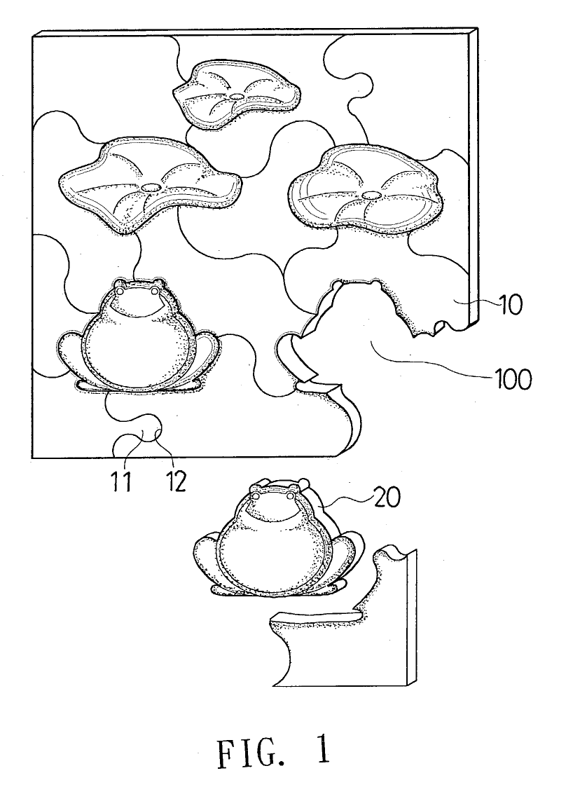

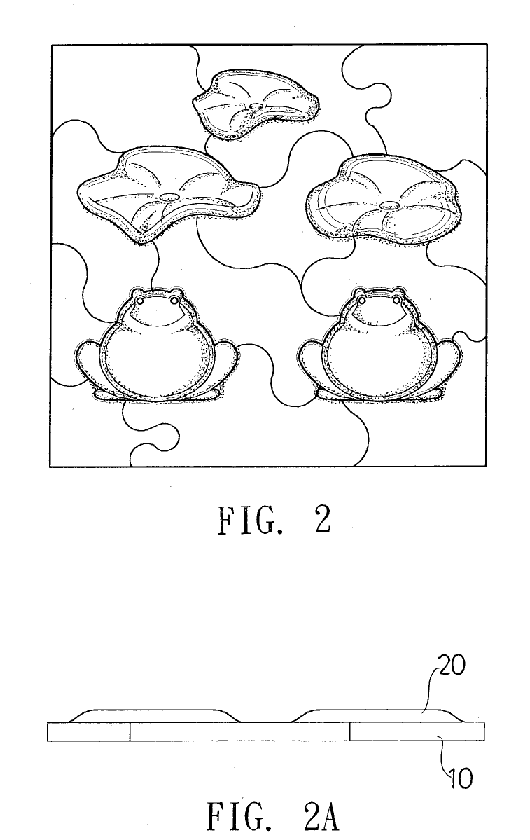

Referring to the drawings and initially to FIGS. 1, 2 and 2A, an assembled pad form by multiple EVA mats in accordance with the present invention comprises multiple assemble mats (10) connected to one another to define at least one cavity (100) for receiving at least one subject matter (20) within the assembled pad.

Each assembled mat (10) has a irregular shape, at least one tenon (11) laterally extending from the assembled mat (10) and at least one mortise (12) laterally defined in the assembled mat (10) for receiving a corresponding one of the tenons (11) of a corresponding one of adjacent assembled mats (10). The subject matter (20) of the present invention can be a three-dimensional model, such as an animal or a plant. In the preferred embodiment of the present invention, the subject matters (20) are frogs and lotus leaves.

The assembled pad has an undulated top surface on which an infant child plays. For a smooth touch, the connecting edges between two adjacent assembled mats (10), and the subject matter (20) and the assembled mats (10) are flushed on each other.

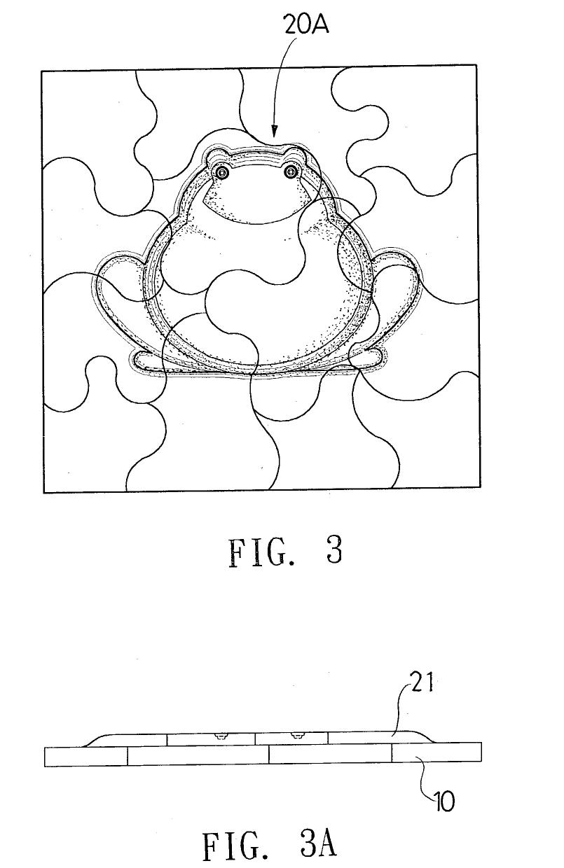

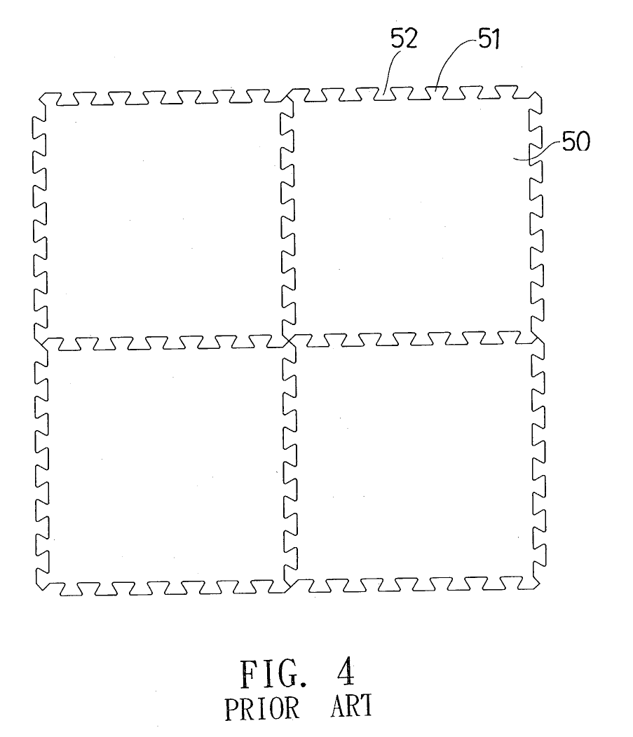

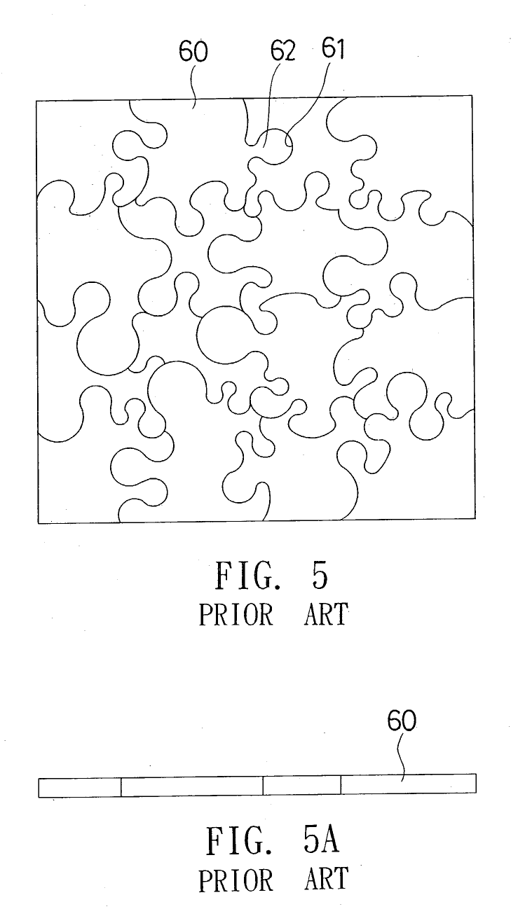

With reference to FIGS. 3 and 3A, a second embodiment of the assembled pad in accordance with the present invention is shown that the subject (20A) is divided into multiple pieces (21). Consequently, the user can use the multiple pieces (21) to piece together the subject matter (20A) such that the assembled pad of the present invention can be used as a teaching aid for training the infant child in harmony with eyes and hands.

As described above, the assembled pad formed by multiple EVA mats in accordance with the present invention has several advantages as follow.

1. The EVA assembled pad of the present invention has a vivid vision due to the undulated top surface thereof and the subject matter with model. The undulated top surface can provide an excitation to the soles of an infant child who plays on the EVA assembled floor and the subject matter with model is attractive to the infant child.

2. The EVA assembled pad of the present invention can provide a good protection to the infant child to prevent the infant child from an injury due to the hard floor and a decoration in playroom.

3. The EVA assembled pad of the present invention can be used as a teaching aid for training the infant child in harmony with eyes and hands.

4. The present invention is made of EVA that is durable, non-toxic, dustproof and easy to clean.

Although the invention has been explained in relation to its preferred embodiment, it is to be understood that many other possible modifications and variations can be made without departing from the spirit and scope of the invention as hereinafter claimed.

What is claimed is:

1. An assembled pad comprising:
multiple assembled mats connected to one another to define at least cavity for receiving at least one subject matter within the assembled pad, each assembled mat made of EVA (Ethylene Vinyl Acetate) and including at least one tenon laterally extending therefrom and at least one mortise laterally defined to receive a corresponding one of the tenons of a corresponding one of adjacent assembled mats; wherein the improvement comprises:
the assembled pad having an undulated top surface adapted to provide an excitation to an infant child who plays on the assembled floor;
each assembled mat having an irregular shape and a connecting edge between two adjacent assembled mats, and the subject matter and the assembled mats being flushed on that of an adjacent assembled mat for a smooth touch; and
the subject matter being a three-dimensional model such that the assembled pad has a vivid vision.

2. The assembled pad as claimed in claim 1, wherein the subject matter is divided into multiple pieces such that the assembled pad can be used as a teaching aid for training the user in harmony with eyes and hands.
